(19) United States
(12) Patent Application Publication
(10) Pub. No.: US 2024/0163645 A1
(43) Pub. Date: May 16, 2024

(54) LEARNING DEVICE, PATH ESTIMATION SYSTEM, AND LEARNING METHOD

(71) Applicant: Panasonic Intellectual Property Management Co., Ltd., Osaka (JP)

(72) Inventors: Naganori SHIRAKATA, Osaka (JP); Mei OKAMOTO, Kanagawa (JP)

(21) Appl. No.: 18/576,283

(22) PCT Filed: Mar. 17, 2022
(86) PCT No.: PCT/JP2022/012170

§ 371 Date: Jan. 3, 2024

(30) Foreign Application Priority Data
Jul. 9, 2021 (JP) 2021-114136

(51) Int. Cl. H04W 4/029

(52) U.S. Cl. CPC H04W 4/029

(57) ABSTRACT

This learning device is provided with: collection circuits (105, 106) for collecting step operation information indicating the operational state of each step, and reception level information that includes a reception level of a signal received by a first wireless station (104) from each of second wireless stations (103-1 to 103-3) installed for each step; and a learning circuit (108) for using teaching data formed of the step operation information and the reception level information linked to each other for each step to cause a generation model for estimating the operational state of a third wireless station (102) to learn.

### TECHNICAL FIELD

The present disclosure relates to a learning apparatus, a path estimation system, and a learning method.

### BACKGROUND ART

One of production systems of industrial products is a cell production system which is highly adaptable to low-volume, high-mix production and fluctuation in amount of production. The cell production system is a system in which a product assembly process is completed by one worker or a small number of workers, and one worker is in charge of a plurality of processes. Since grasping processes conducted by a worker, the order of the processes conducted by the worker, and a path in which the worker has moved between the processes for conducting the processes becomes information for productivity management, there is a need to detect the relation between the (working) position of a worker and the operation states of processes (process-in-operation information).

Various techniques exist as indoor position estimation techniques considered to be applicable to such a cell production system, but the demand for position estimation to which a radio communication technique is applied has been increasing. For example, Patent Literature (hereinafter referred to as “PTL”) 1 discloses a technique in which a list of radio wave intensities (which is referred to as a radio map or fingerprint) from numerous access points is collected in advance and the position of a terminal is estimated based on the list of radio wave intensities.

### CITATION LIST

### Patent Literature

PTL 1

Japanese Patent Application Laid-Open No. 2021-056222

### SUMMARY OF INVENTION

### Technical Problem

In the cell production system, there are numerous cases where a plurality of workers is present within a relatively narrow area and process-in-operation information by the plurality of workers is mixedly present in process-in-operation information for each process.

Separation of process-in-operation information by a plurality of workers for each worker by using a position estimation technique requires high-level position estimation accuracy. In a case where the position estimation accuracy of a fingerprint system is low, however, it is difficult to associate process-in-operation information with cell process arrangement, for example, the (working) position of a worker even when the technique as disclosed in PTL 1 is applied to the cell production system. For this reason, it is difficult to grasp processes conducted by a worker, the order of the processes conducted by the worker, and a path in which the worker has moved between the processes for conducting the processes.

One non-limiting and exemplary embodiment facilitates providing a learning apparatus, a path estimation system, and a learning method each capable of estimating processes conducted by a worker, the order of the processes conducted by the worker, and a path in which the worker has moved between the processes for conducting the processes even by using a fingerprint system.

A learning apparatus according to an exemplary embodiment of the present disclosure includes: a collector that collects process-in-operation information, which indicates an operation state of each process, and reception level information, which includes a reception level of a signal received by a first radio station from a second radio station installed in each process; and a learner that causes a generation model for estimating a movement state of a third radio station to be learned by using training data in which the process-in-operation information and the reception level information are associated for each process.

A path estimation system according to an exemplary embodiment of the present disclosure includes: the learning apparatus described above; and an estimator that estimates the movement state based on a process-in-operation information sequence, a reception level information sequence including reception levels of signals received by the third radio station from a plurality of the second radio stations, and the generation model.

A learning method according to an exemplary embodiment of the present disclosure includes: collecting process-in-operation information, which indicates an operation state of each process, and reception level information, which includes a reception level of a signal received by a first radio station from a second radio station installed in each process; and causing a generation model for estimating a movement state of a third radio station to be learned by using training data in which the process-in-operation information and the reception level information are associated for each process.

It should be noted that general or specific embodiments may be implemented as a system, an apparatus, a method, an integrated circuit, a computer program, a storage medium, or any selective combination thereof.

According to an exemplary embodiment of the present disclosure, it is possible to estimate processes conducted by a worker, the order of the processes conducted by the worker, and a path in which the worker has moved between the processes for conducting the processes even by using a fingerprint system.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a configuration diagram illustrating an example of a path estimation system in an embodiment of the present disclosure;

FIG. 2 illustrates an example of a process label sequence in the embodiment of the present disclosure;

FIG. 3 illustrates examples of process labels and fingerprints in the embodiment of the present disclosure;

FIG. 4 is a configuration diagram illustrating an example of a learner in the embodiment of the present disclosure;

FIG. 5 is a flowchart illustrating an example of a learning method in the embodiment of the present disclosure;

FIG. 6 is a configuration diagram illustrating an example of a path estimator in the embodiment of the present disclosure;

FIG. 7 is a flowchart illustrating an example of a path estimation method in the embodiment of the present disclosure;

FIG. 8 illustrates exemplary candidate sequences in the embodiment of the present disclosure;

FIG. 9 illustrates an example of an inter-process movement probability table in the embodiment of the present disclosure;

FIG. 10 illustrates examples of an observation fingerprint sequence and reconstruction fingerprint sequences in the embodiment of the present disclosure;

FIG. 11 illustrates an example of displaying by a display in the embodiment of the present disclosure; and

FIG. 12 illustrates another example of the displaying by the display in the embodiment of the present disclosure.

### DESCRIPTION OF EMBODIMENTS

Hereinafter, an embodiment of the present disclosure will be described in detail with reference to the accompanying drawings as appropriate. Having said that, a detailed description more than necessary may be omitted, such as a detailed description of an already well-known matter and a duplicated description for a substantially identical configuration, to avoid the following description becoming unnecessarily redundant and to facilitate understanding by those skilled in the art.

Note that, the accompanying drawings and the following description are provided for those skilled in the art to sufficiently understand the present disclosure, and are not intended to limit the subject matter described in the claims.

### Embodiment

### Path Estimation System

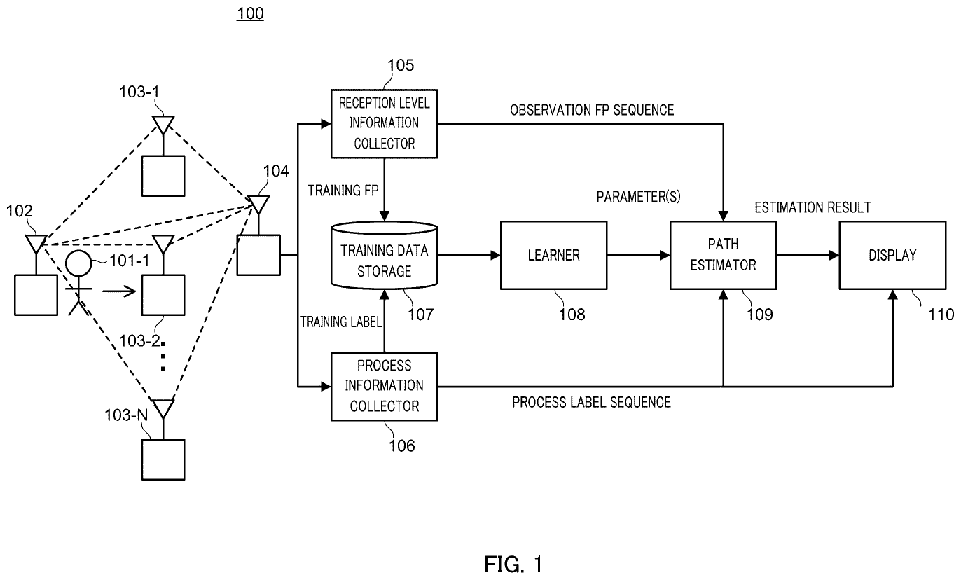

FIG. 1 is a configuration diagram illustrating an example of path estimation system 100 in an embodiment of the present disclosure.

Path estimation system 100 estimates, with respect to worker 101 who moves between processes and works in the processes, processes conducted by worker 101, the order of the processes conducted by worker 101, and a path in which worker 101 has moved between the processes for conducting the processes (for example, a movement state of portable sensor 102 associated with worker 101 between the processes), and presents the estimated processes, order, and path (hereinafter referred to as an estimation result) to the user (for example, a process manager, a system manager, or the like). Note that, the movement in the present disclosure includes not only movement between different processes but also remaining in the same process for perform the same work. Hereinafter, estimating a path (or path estimation) means estimating processes conducted by a worker, the order of the processes conducted by the worker, and a path in which the worker has moved between the processes for conducting the processes.

Path estimation system 100 includes portable sensor 102, process sensors 103-1 to 103-N (where N is an integer equal to or greater than 2), parent station 104, reception level information collector 105, process information collector 106, training data storage 107, learner 108, path estimator 109, and display (monitor) 110.

In the present embodiment, parent station 104, reception level information collector 105, process information collector 106, training data storage 107, learner 108, path estimator 109, and display 110 are implemented as one computer apparatus or a plurality of computer apparatuses.

Path estimation system 100 is an example of the path estimation system according to the present disclosure. Reception level information collector 105, process information collector 106, training data storage 107, and learner 108 are examples of the learning apparatus according to the present disclosure. Reception level information collector 105 and process information collector 106 are examples of the collector according to the present disclosure. Learner 108 is an example of the learner according to the present disclosure. Path estimator 109 is an example of the estimator according to the present disclosure.

Process sensors 103-1 to 103-N are referred to as process sensor(s) 103 in a case where process sensors 103-1 to 103-N need not be distinguished from each other. In addition, portable sensor (radio terminal apparatus, third radio station) 102, process sensors (second radio station) 103, and parent station (radio base station apparatus, first radio station) 104 may be collectively referred to as radio stations (radio apparatuses).

Portable sensor 102, process sensors 103, and parent station 104 are connected in the same radio network by, for example, WiFi (registered trademark) or Bluetooth (registered trademark). The radio connection relationship among these radio stations is partially indicated with the dotted lines in FIG. 1, for example.

Portable sensor 102 is carried and held by worker 101 who works within a process. Here, the ID of portable sensor 102 and worker 101 (for example, the ID of worker 101) are associated one-to-one. The ID of the portable sensor and, for example, the ID of worker 101 which have been associated are stored, for example, in the form of a table in a storage(s) (such as a memory or memories; not illustrated) of the one computer apparatus or the plurality of computer apparatuses as described above. Portable sensor 102 periodically performs radio transmission of the ID of portable sensor 102 itself to parent station 104.

When portable sensor 102 receives or intercepts a radio signal from another radio station, portable sensor 102 causes a reception level thereof, such as a reception power and a received signal strength (RSSI: Received Signal Strength Indicator), and the ID of the transmission source to be stored in association with the clock time, at which portable sensor 102 has received the radio signal, as reception level information in the storage of portable sensor 102 itself. Portable sensor 102 periodically performs radio transmission of stored reception level information to parent station 104.

Portable sensor 102 performs radio transmission of the ID of portable sensor 102 and reception level information to parent station 104 at the same timing. Thus, the ID of portable sensor 102 and the reception level information are associated.

Sensors 103-1 to 103-N are installed in N working processes (also simply referred to as processes), respectively. When worker 101 works in a given process, process sensor 103 installed in the process performs radio transmission of information changing with time, which includes process-in-operation information and process-not-in-operation information, to parent station 104. The process-in-operation information indicates that the process is in operation (the operation state of the process), for example, that given worker 101-1 is present in the process. The process-not-in-operation information indicates that the process is not in operation (the non-operation state of the process), for example, that every worker 101 is absent in the process. Note that, each process sensor 103 does not identify the ID of worker 101 in the process and the process-in-operation information is not associated with worker 101 (for example, the ID of worker 101).

For example, in FIG. 1, the arrow from worker 101-1 to process sensor 103-2 means the work of worker 101-1 in process “2”. At this time, process sensor 103-2 performs radio transmission of the process-in-operation information on process “2” to parent station 104. Other process sensors 103 operate in the same manner.

When process sensor 103 receives or intercepts a radio signal from another radio station, process sensor 103 causes a reception level thereof, such as a reception power and an RSSI, and the ID of the transmission source to be stored in association with the clock time, at which process sensor 103 has received the radio signal, as reception level information in the storage of process sensor 103 itself. Process sensor 103 periodically performs radio transmission of stored reception level information to parent station 104.

Parent station 104 receives the ID of portable sensor 102 and the reception level information on portable sensor 102, of both of which the radio transmission has been performed by portable sensor 102, and receives the process information on process sensor 103 and the reception level information on process sensor 103, of both of which the radio transmission has been performed by process sensor 103.

In a case where parent station 104 has received radio signals from portable sensor 102 and process sensor 103, parent station 104 outputs reception levels thereof, such as reception powers and RSSIs, and the IDs of the transmission sources in association with the clock times, at which parent station 104 has received the radio signals, as reception level information on parent station 104 to reception level information collector 105. Further, parent station 104 outputs the received ID of portable sensor 102, the received reception level information on portable sensor 102, and the received reception level information on process sensor 103 to reception level information collector 105. Further, parent station 104 outputs the received process information on process sensor 103 to process information collector 106.

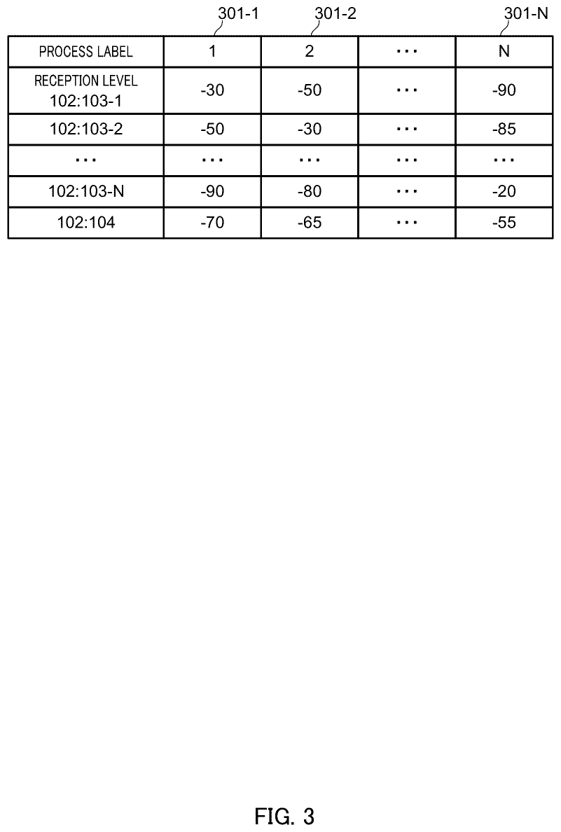

Reception level information collector 105 receives reception level information on all, one or some of the radio stations in the radio network, where the reception level information has been inputted from parent station 104. Reception level information collector 105 generates and collects reception level information (also referred to as a FingerPrint (FP) or FP vector) obtained by, for example, as illustrated in FIG. 3 to be described later, arranging inputted reception levels in a predetermined order and performing vectorization for each process (for each process label). An FP and an FP sequence generated in the above-described manner are also referred to as an observed FP and an observed FP sequence, or an observation FP and an observation FP sequence, respectively. Note that, although not illustrated, information on clock times may also be included in FIG. 3.

When learner 108 of path estimation system 100 performs learning, reception level information collector 105 causes a generated FP to be stored as input data for training in training data storage 107.

During process operation (when it is desired to estimate the path of worker 101), reception level information collector 105 outputs a generated FP sequence to path estimator 109.

Reception level information collector 105 is capable of capturing a change in an FP according to the position of worker 101 by collecting the FP at a speed sufficiently faster than the moving speed and/or working speed of worker 101.

Process information collector 106 collects and aggregates process-in-operation information from process sensor 103, where the process-in-operation information has been inputted from parent station 104.

When learner 108 of path estimation system 100 performs learning, process information collector 106 causes a process label indicating a process, in which worker 101 has been present, to be stored as a training label (a process label as training data) in training data storage 107.

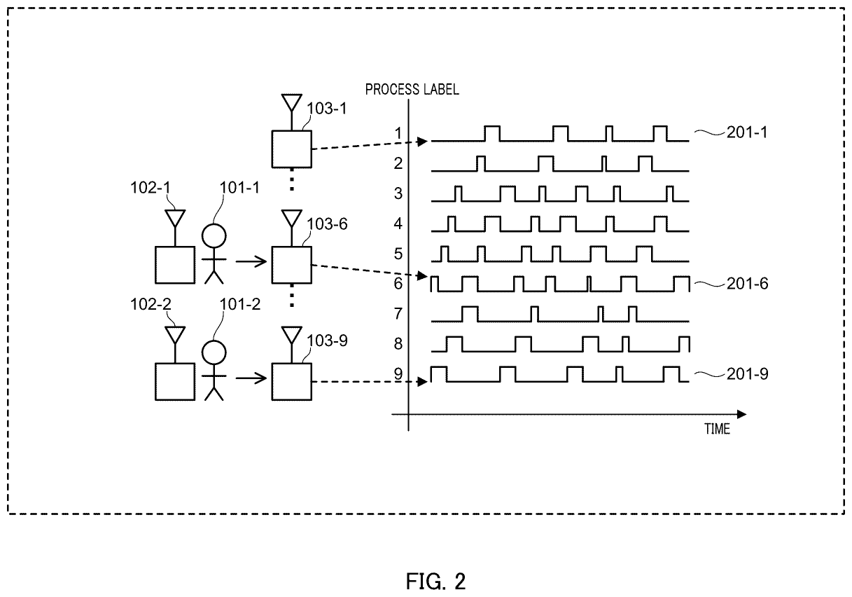

During process operation (when it is desired to estimate the path of worker 101), process information collector 106 outputs aggregated process-in-operation information as a process label sequence to path estimator 109. An example of the process label sequence will be described later with reference to FIG. 2.

Process information collector 106 outputs aggregated process-in-operation information as a process label sequence to display 110.

Training data storage 107 stores training data for learning an FP model for estimating processes conducted by worker 101, the order of the processes conducted by worker 101, and a path in which worker 101 has moved between the processes for conducting the processes (a movement state of portable sensor 102 associated with worker 101 between the processes). The training data and the FP model associate the position of a worker (for example, a process in which the worker is present and is in operation, or a process label) with the FP at that time. Accordingly, training data storage 107 stores training data of a set of a process label when a worker is present in a given process and the FP observed at that time.

As a model for training in advance, for example, worker 101 who holds portable sensor 102 works in a predetermined order of processes to thereby move portable sensor 102 between a plurality of the processes, and training data are then collected as a set of a known process label and the FP observed when worker 101 is present in the process thereof, and are stored in training data storage 107. An example of the training data will be described later with reference to FIG. 3.

Learner 108 learns an FP model by using a process label and an FP which are stored in training data storage 107. Learner 108 outputs a parameter(s) of the learned FP model to path estimator 109. Note that, as the FP model, a generation model using various machine learning algorithms can be used. Hereinafter, a case where a Conditional Variational AutoEncoder (CVAE) is used as the FP model (generation model) will be described.

Path estimator 109 estimates relevance of an FP sequence to a process label sequence, both of which have been observed during process operation, by using a parameter(s) of an FP model learned by learner 108, and estimates the path of worker 101. Path estimator 109 outputs an estimation result including the estimated path of worker 101 to display 110.

Display 110 displays paths or the like, which are separated for each process label sequence and for each worker ((the ID of) portable sensor 102) during process operation, to the user.

FIG. 2 illustrates an example of a process label sequence in the embodiment of the present disclosure.

In FIG. 2, process labels “1” to “9” are assigned to nine process sensors 103-1 to 103-9, respectively. Process information from each of process sensors 103-1 to 103-9 is treated as time-series data in which the process information is combined with clock times. For example, process-in-operation information (process label sequence (also referred to as process-in-operation information sequence) as the time-series data is associated with clock times.

For example, process information from process sensor 103-1 is indicated as time-series data 201-1. The process information from process sensor 103-1 is indicated in L level as process-not-in-operation information during non-operation, and is indicated in H level as process-in-operation information during operation. Further, workers 101-1 and 101-2 simultaneously work in processes 6 and 9, respectively, and time-series data 201-6 and 201-9 are simultaneously in H level in a period of time during which workers 101-1 and 101-2 simultaneously work in processes 6 and 9.

Note that, since the process-in-operation information is not associated with worker 101 (for example, the ID of worker 101) as described above, it is difficult, only based on time-series data 201-6, to grasp worker 101-1 who has worked in process 6.

FIG. 3 illustrates examples of process labels and FPs in the embodiment of the present disclosure.

Process labels 301-1 to 301-N (where “1” to “N” are assigned to process sensors 103-1 to 103-N, respectively) illustrated in FIG. 3 indicate positions (processes) in which worker 101 has been present.

A column vector (for example, [−30 −50 . . . −90 −70]^{T}) (unit: dBm) of reception levels of radio signals received by portable sensor 102 from process sensors 103-1 to 103-N and parent station 104 illustrated in FIG. 3 indicates an FP. The FP used as input data for training may be collected using one portable sensor 102 held by one representative or the like of workers or may be collected using a plurality of portable sensors 102 held by a plurality of workers, respectively.

### Details of Learner

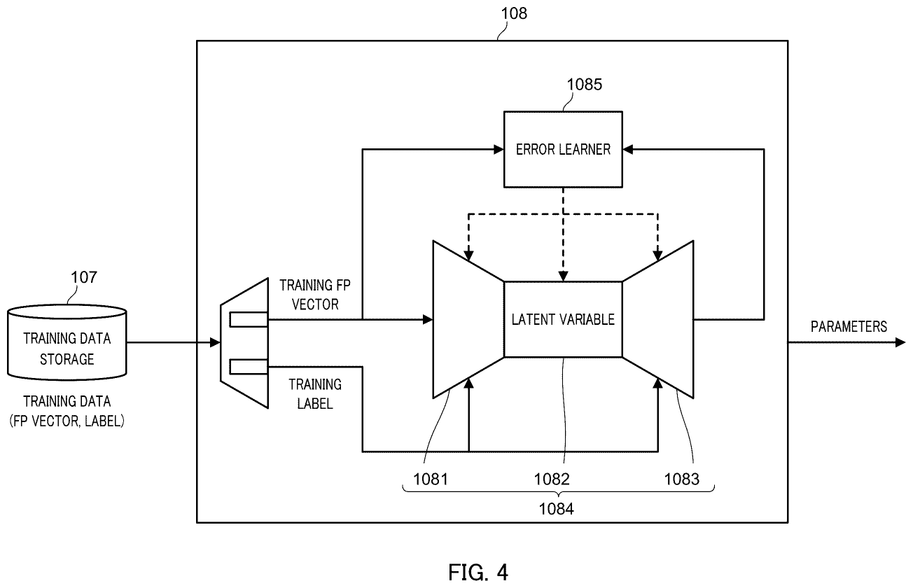

FIG. 4 is a (an inner) configuration diagram illustrating an example of learner 108 in the embodiment of the present disclosure. In the present embodiment, the CVAE is used as the generation model. Learner 108 performs learning with an encoder and a decoder. The encoder that compresses an input vector (FP) corresponding to a label into a low-dimensional latent variable. The decoder reconstructs the input vector (FP) by using the latent variable having been inputted into the decoder. A reconstructed FP and a reconstructed FP sequence are also referred to as a reconstruction FP and a reconstruction FP sequence, respectively.

Learner 108 includes: generation model (FP model) 1084, which is configured to include encoder 1081, latent variable 1082, and decoder 1083; and error learner 1085.

Encoder 1081 includes, for example, a neural network. Encoder 1081 receives inputs of a training FP vector and a training label (a process label as training data) which are stored in training data storage 107, and determines a low-dimensional mean vector and a low-dimensional variance vector based on these inputs.

Encoder 1081 samples latent variable 1082 from a multivariate Gaussian distribution based on the determined low-dimensional mean vector and low-dimensional variance vector. Thus, encoder 1081 performs dimensional compression with a certain degree of randomness in the mean vector to determine latent variable 1082 after the dimensional compression. Encoder 1081 outputs latent variable 1082 to decoder 1083.

Decoder 1083 includes, for example, a neural network. Decoder 1083 receives inputs of latent variable 1082, which is compressed into low dimensions, and a training label (a process label as training data) stored in training data storage 107, where the training label is the same as that inputted into encoder 1081, and reconstructs the (original high-dimensional) FP vector based on these inputs. Decoder 1083 outputs the reconstructed FP vector to error learner 1085. Note that, the randomness means that FP vectors reconstructed from the same process label may fluctuate at least partially. Due to the randomness, reconstruction of vectors which are slightly apart in a vector space is performed. For this reason, it is possible to increase variations of a reconstruction FP sequence.

Error learner 1085 adjusts parameters (for example, weight, mean vector, variance vector, and/or the like) of encoder 1081, latent variable 1082, and decoder 1083 so as to minimize an error between a reconstruction FP vector inputted from encoder 1081 and a training FP vector inputted into encoder 1081, and learns these parameters of generation model 1084. Note that, for learning these parameters, various optimization methods such as stochastic gradient descent can be used.

Learner 108 outputs the parameters learned in the above-described manner to path estimator 109 for setting the generation model in path estimator 109.

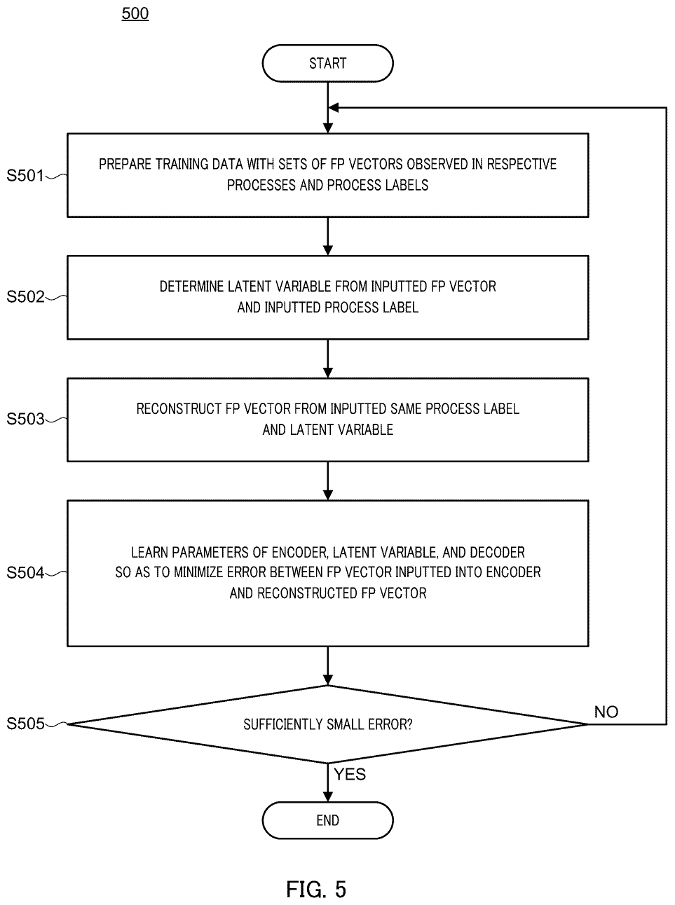

FIG. 5 is a flowchart illustrating an example of learning method 500 in the embodiment of the present disclosure.

In step S501, as training data for training, sets of N process labels and FP vectors observed in the respective processes are prepared in advance as illustrated in FIG. 3. Specifically, reception level information collector 105 and process information collector 106 cause sets of process labels and FP vectors to be stored as training data in training data storage 107. Learner 108 learns the CVAE by using these training data.

In step S502, encoder 1081 determines a low-dimensional mean vector and a low-dimensional variance vector from an inputted FP vector and an inputted process label, and samples latent variable 1082 from a multivariate Gaussian distribution based on the low-dimensional mean vector and variance vector to thereby determine latent variable 1082 after dimensional compression.

In step S503, decoder 1083 reconstructs the FP vector from an inputted process label, which is the same as that inputted into encoder 1081, and latent variable 1082 having been low-dimensionally compressed.

In step S504, error learner 1085 learns parameters of encoder 1081, latent variable 1082, and decoder 1083 so as to minimize an error between the FP vector inputted into encoder 1081 and the reconstructed FP vector inputted from decoder 1083.

When the error in step S504 is within a predetermined small value, for example, when a reconstructed FP sequence with a predetermined sufficiently small error has been generated with respect to a training FP sequence, learner 108 ends learning (YES in step S505). When the error in step S504 is not within the predetermined small value, on the other hand, steps (S501,) S502, S503, and S504 are repeated (NO in step S505).

### Details of Path Estimator

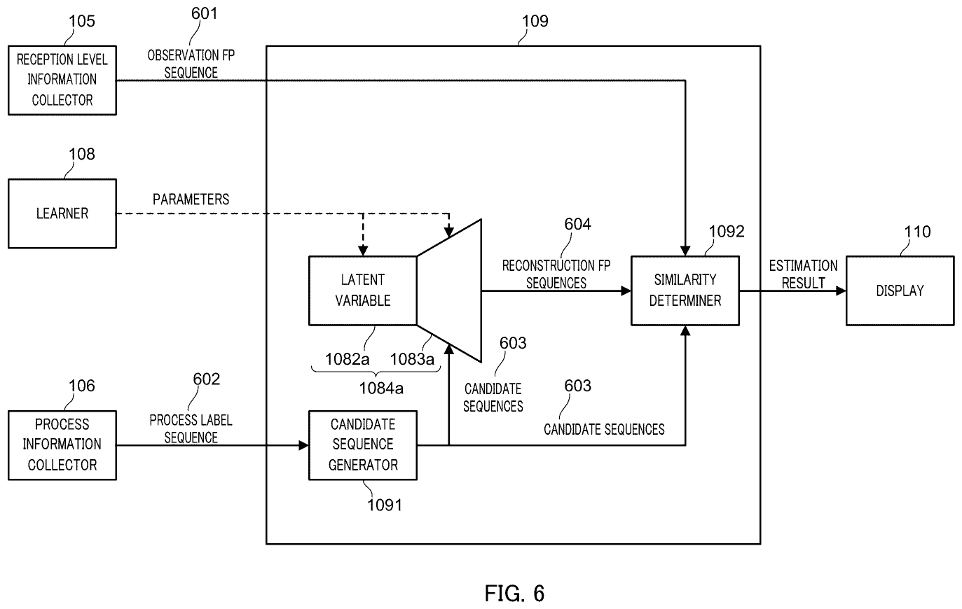

FIG. 6 is a (an inner) configuration diagram illustrating an example of path estimator 109 in the embodiment of the present disclosure. Path estimator 109 generates a plurality of possible candidate sequences from process-in-operation information (process label sequence) observed during process operation. Path estimator 109 reconstructs an FP sequence based on the generated candidate sequences and a generation model having been already learned. Path estimator 109 determines similarity between an observed FP sequence associated with the ID of portable sensor 102 and the reconstructed FP sequence. Then, path estimator 109 selects a candidate sequence from the plurality of candidate sequences based on a result of the similarity determination to thereby estimate the selected candidate sequence as the path of worker 101.

Path estimator 109 includes candidate sequence generator 1091, generation model 1084a that has been already learned, and similarity determiner 1092.

Candidate sequence generator 1091 generates a plurality of possible candidate sequences from process label sequence 602 that has been inputted from process information collector 106 and has been observed. Candidate sequence generator 1091 outputs the generated plurality of candidate sequences to generation model 1084a that has been already learned and similarity determiner 1092. Note that, process label sequence 602 that has been observed is a sequence of process labels obtained from process sensor 103.

Generation model 1084a that has been already learned is configured to include latent variable 1082a and decoder 1083a which have the parameters learned by and inputted from learner 108. Note that, latent variable 1082a and decoder 1083a are the same as latent variable 1082 and decoder 1083 of generation model 1084 of learner 108, respectively, whereas generation model 1084a differs from generation model 1084 of learner 108 in terms of not including any encoder.

Generation model 1084a reconstructs, for each candidate sequence, an FP sequence by using process labels of the candidate sequence, which has been inputted from candidate sequence generator 1091 into decoder 1083, and a random number, which has been inputted into latent variable 1082a, to generate reconstruction FP sequence 604.

Specifically, process labels of a candidate sequence are inputted into decoder 1083a and a random number sampled from a multivariate Gaussian distribution according to the parameter(s) of latent variable 1082a is inputted into latent variable 1082a, and thus, generation model 1084a (decoder 1083a) reconstructs an FP sequence with a certain degree of randomness.

Generation model 1084a (decoder 1083a) outputs the generated reconstruction FP sequence 604 to similarity determiner 1092.

Similarity determiner 1092 determines similarity between observation FP sequence 601 inputted from reception level information collector 105 and each of a plurality of reconstruction FP sequences 604 inputted from generation model 1084a (decoder 1083a), and determines which reconstruction FP sequence has the highest similarity. In this similarity determination, similarity determiner 1092 may use the Euclidean distance between vectors and may determine that a reconstruction FP sequence having a close distance has a high similarity, for example. Similarity determiner 1092 selects, among the plurality of candidate sequences, a candidate sequence resulting in a reconstruction FP sequence having the highest similarity as prediction processes conducted by a worker, a prediction order of the processes conducted by the worker, and a prediction path in which the worker has moved between the processes to thereby estimate the selected prediction processes, prediction order, and prediction path as the path of worker 101. Similarity determiner 1092 outputs an estimation result of the estimation to display 110.

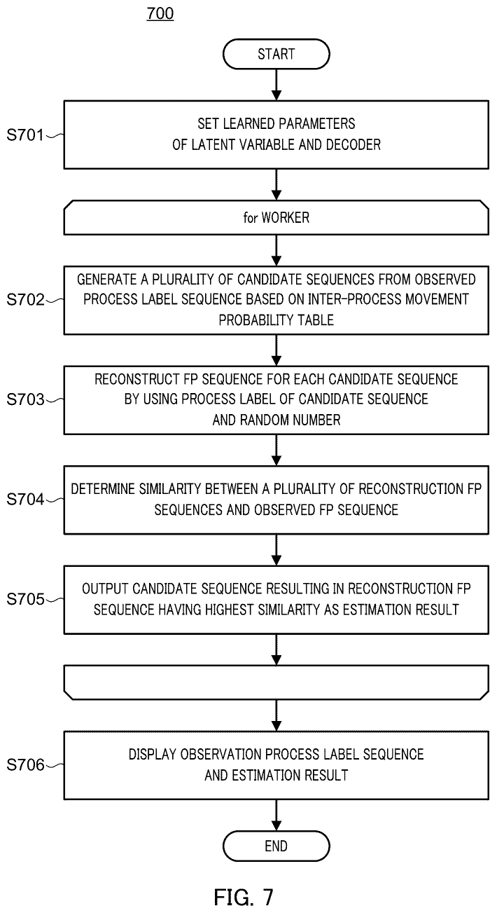

FIG. 7 is a flowchart illustrating an example of path estimation method 700 in the embodiment of the present disclosure.

In step S701, path estimator 109 sets the parameters, which have been learned by learner 108, to generation model 1084a (latent variable 1082a and decoder 1083a).

In step S702, candidate sequence generator 1091 generates a plurality of candidate sequences from an observed process label sequence based on an inter-process movement probability table, for example, for a period of time during which it is desired to perform user input-based path estimation for display 110. Details of step S702 will be described later.

In step S703, generation model 1084a reconstructs an FP sequence for each generated candidate sequence by using a process label of the candidate sequence and a random number to generate a reconstruction FP sequence.

In step S704, similarity determiner 1092 determines similarity between a generated plurality of reconstruction FP sequences and an observed FP sequence.

In step S705, similarity determiner 1092 outputs, as an estimation result, a candidate sequence resulting in a reconstruction FP sequence having the highest similarity to display 110.

Path estimator 109 performs path estimation for each worker ((the ID of) portable sensor 102) by repeating steps S702 to S705 for each worker for the period of time during which it is desired to perform the path estimation.

In step S706, display 110 displays the observed process label sequence, the estimation result including each estimated path for each worker, or the like.

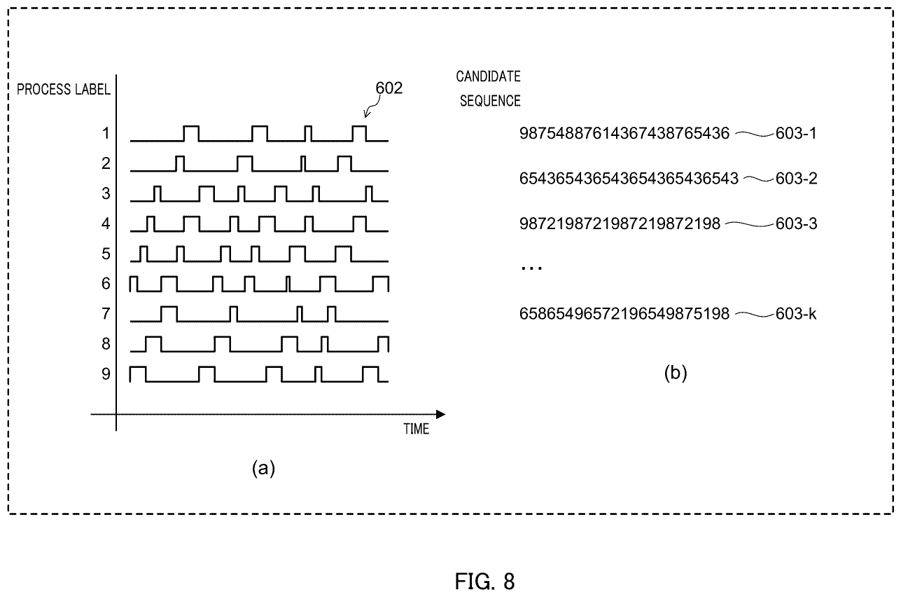

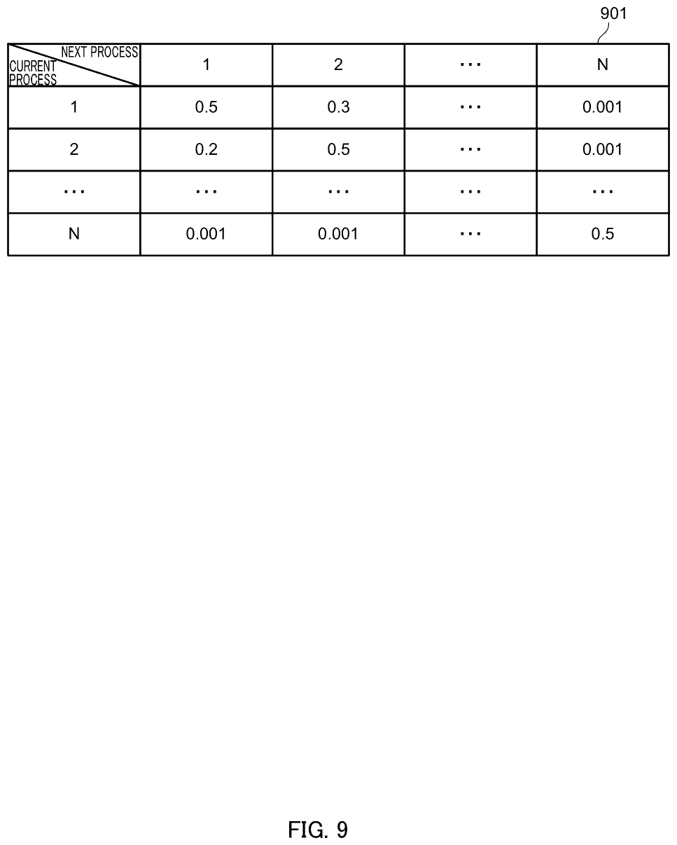

Details of step S702 will be described with reference to FIGS. 8 and 9.

FIG. 8 illustrates exemplary candidate sequences 603-1 to 603-K in the embodiment of the present disclosure. For example, it is assumed that process label sequence 602 as illustrated in FIG. 8(a) is observed. When the process labels that have moved along the time are sequentially taken out one by one from process label sequence 602 in FIG. 8(a), numerous combinations of candidate sequences 603-1 to 603-k are conceivable as illustrated in FIG. 8(b). For example, candidate sequence 603-1 indicates a possibility of movement in the order of process 9→process 8→process 7→process 5→process 4→ . . . →process 3→process 6. At this time, all inter-process movement (transition) probabilities are not necessarily equal. In view of the fact that the movement probabilities are not necessarily equal as described above, the number of combinations of candidate sequences can be limited by considering that the probability of movement considered in production process design is high.

FIG. 9 illustrates an example of inter-process movement probability table 901 in the embodiment of the present disclosure. Candidate sequence generator 1091 may generate candidate sequences by considering the inter-process movement probabilities as illustrated in FIG. 9.

For example, inter-process movement probability table 901 is a table in which current process labels are taken in the vertical, next process labels are taken in the horizontal, and a probability of movement from a current process label to a next process label is an element at an intersection thereof. Basically, there is a high probability of continued work in the same process, followed by a high probability of movement to a near, neighboring process in the order of locations and production procedures. On the other hand, a probability of movement to a distant process is low. As described above, the probabilities in inter-process movement probability table 901 can be dynamically adjusted according to elements such as procedure design and layout of the production line and further the degrees of skill of workers.

For example, it can be considered that a probability that worker 101-3 in charge of process labels 6 to 3 will perform repeated work of these processes is high. In view of such a probability, candidate sequence generator 1091 generates candidate sequence 603-2 as illustrated in FIG. 8 according to inter-process movement probability table 901 as illustrated in FIG. 9.

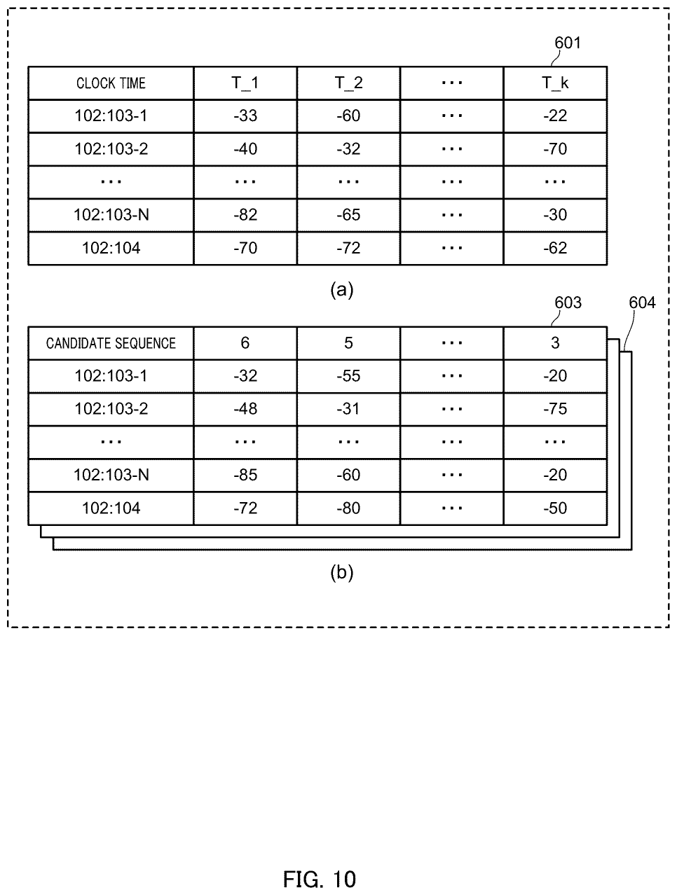

FIG. 10 illustrates examples of observation FP sequence 601 and reconstruction FP sequences 604 in the embodiment of the present disclosure. FIG. 10(a) illustrates reception levels due to transmission and reception (radio link) among portable sensor 102, and process sensors 103-1 to N, and parent station 104 from clock times T_1 to T_k.

For example, in FIG. 10(b), FP vectors reconstructed with respect to process labels (6 to 3) of candidate sequence 603, respectively, are combined laterally (in time-series) to form reconstruction FP sequence 604.

In step S703, generation model 1084a generates such reconstruction FP sequences according to the number of generated candidate sequences.

Similarity determiner 1092 determines similarity between observation FP sequence 601 as illustrated in FIG. 10(a) and reconstruction FP sequences 604 as illustrated in FIG. 10(b) in step S704 and outputs a candidate sequence resulting in a reconstruction FP sequence having the highest similarity as an estimation result in step S705.

### Displaying of Estimation Result or the Like

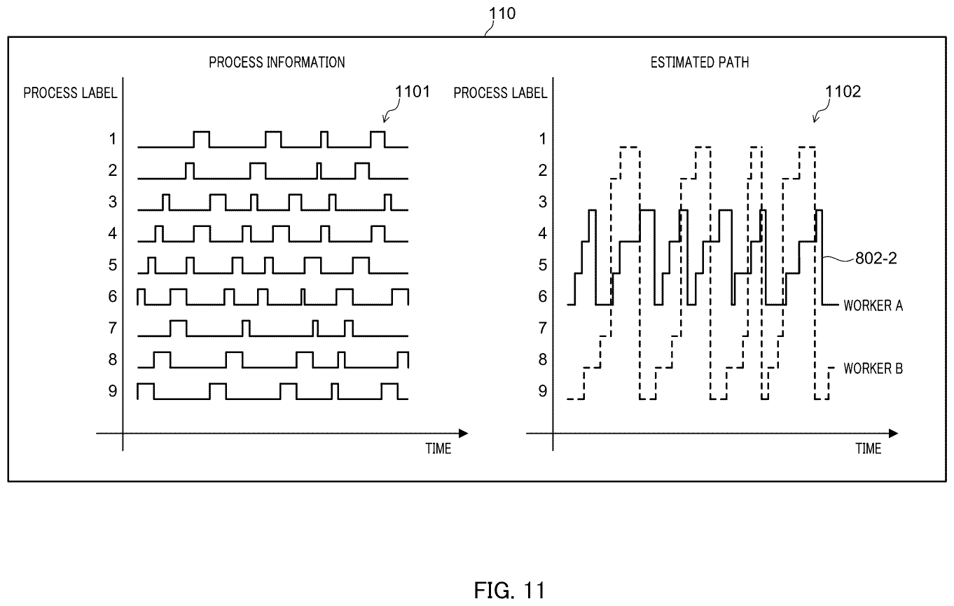

FIG. 11 illustrates an example of displaying by display 110 in the embodiment of the present disclosure.

As illustrated in FIG. 11, display 110 displays process label sequence (illustrated as process information) 1101 observed by process information collector 106 and paths (illustrated as estimated paths) 1102 for each worker 101, which are estimated by path estimator 109. Note that, in FIG. 11, path 802-2 of worker A101a corresponds to candidate sequence 603-2 in FIG. 8.

Here, paths 1102 may be displayed with different colors and/or patterns of lines for each worker 101 so as to facilitate a distinction between a plurality of workers 101. For example, as illustrated in FIG. 11, the path of worker A101a may be displayed as a solid line and the path of worker B101b may be displayed as a dotted line.

As described above, the user can distinguish, for example, process label sequences, processes conducted by workers 101, the orders of the processes conducted by workers 101, paths in which workers 101 have moved between the processes, and the like through display 110, and can perform determination of work efficiency improvement and/or process improvement or the like.

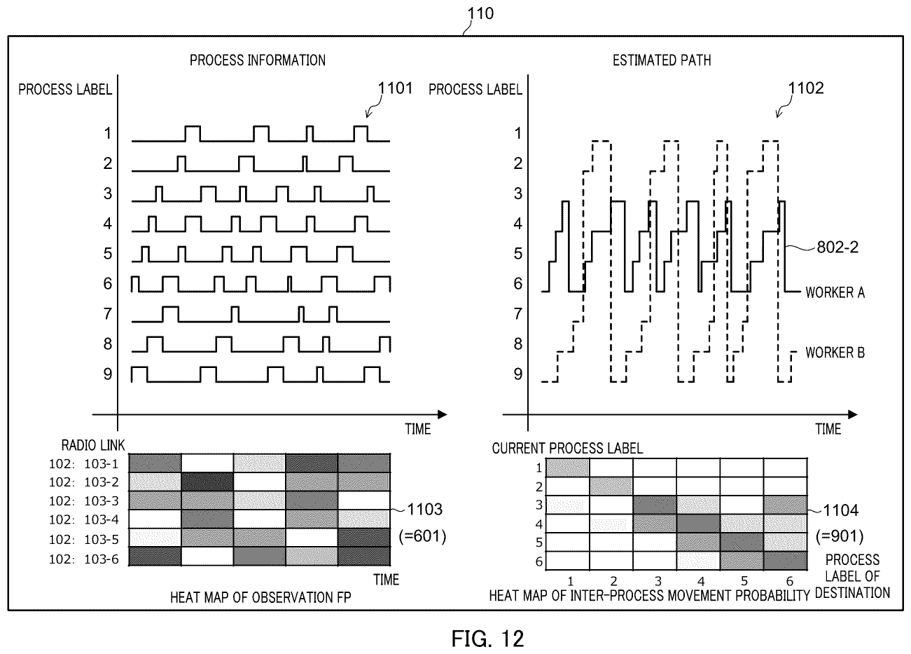

FIG. 12 illustrates another example of the displaying by display 110 in the embodiment of the present disclosure.

As illustrated in FIG. 12, display 110 may display heat map graph 1103 of observation FP sequence 601 and heat map graph 1104 of inter-process movement probability table 901 simultaneously with process label sequence 1101 and paths 1102 so as to indicate relevance to observed FP sequences. By displaying heat map graphs 1103 and 1104 in the above-described manner, part of the path determination criteria can be presented to the user.

Heat map graph 1103 of observation FP sequence 601 indicates temporal changes in reception level between portable sensor 102 and process sensors 103-1 to N (radio link), in which case the darker the color, the higher the reception level. Heat map graph 1104 of inter-process movement probability table 901 indicates a probability of movement from a current process to a process of a destination. Since worker A101a has moved from process 3 to process 6, the color in process 3 through process 6 becomes dark.

### Variation

The present disclosure is, needless to say, not limited to those indicated in the embodiment described thus far, and various variations can be made without departing from the gist thereof.

Although an example in which similarity determiner 1092 outputs, as an estimation result, a candidate sequence resulting in a reconstruction FP sequence having the highest similarity to display 110 has been described above, the present disclosure is not limited to this example.

For example, similarity determiner 1092 may output, instead of outputting a candidate sequence resulting in a reconstruction FP sequence having the highest similarity to display 110, a predetermined plurality of candidate sequences in descending order of similarity for each worker 101 or for one worker 101 to display 110. Correspondingly, display 110 may display estimation results indicating the predetermined plurality of candidate sequences in descending order of similarity.

Further, although an example in which column vectors of reception levels of radio signals received by portable sensor 102 from process sensors 103-1 to 103-N and parent station 104 are used for FPs has been described above, the present disclosure is not limited to this example.

For example, column vectors of reception levels of radio signals received by portable sensor 102 from process sensors 103-1 to 103-N may be used for FPs or column vectors of reception levels of radio signals received by process sensors 103-1 to 103-N from portable sensor 102 may be used for FPs.

Further, for example, column vectors of, in addition to reception levels of radio signals received by portable sensor 102 from process sensors 103-1 to 103-N and parent station 104, reception levels of radio signals received by portable sensor(s) 103 from any other process sensor 103 and parent station 104 may be used for FPs.

### Effects in Embodiment

The learning apparatus in the embodiment of the present disclosure includes: a collector that collects process-in-operation information, which indicates an operation state of each process, and reception level information, which includes a reception level of a signal received by a first radio station from a second radio station installed in each process; and a learner that causes a generation model for estimating a movement state of a third radio station to be learned by using training data in which the process-in-operation information and the reception level information are associated for each process. As described above, the generation model in which the process-in-operation information and the reception level information are associated by using the training data in which the process-in-operation information and the reception level information are associated for each process is learned, and thus, even by using the reception level information, it is possible to estimate processes conducted by a worker who holds the third radio station and is associated with the third radio station, the order of the processes conducted by the worker, and a path in which the worker has moved between the processes. In the same manner, the path estimation system in the embodiment of the present disclosure uses the generation model in which the process-in-operation information and the reception level information are associated, and thus, even by using the reception level information, it is possible to estimate processes conducted by the worker who holds the third radio station and is associated with the third radio station, the order of the processes conducted by the worker, and a path in which the worker has moved between the processes.

Further, the learning apparatus and the path estimation system in the embodiment of the present disclosure use a conditional variational autoencoder as the generation model. The variational autoencoder is also capable of addressing a variation in a radio environment, which differs from that at the time of learning, by reconstructing a reception level information sequence with a certain degree of randomness.

Further, the path estimation system in the embodiment of the present disclosure generates a plurality of candidate sequences from a process-in-operation information sequence based on an inter-process movement probability, and estimates a movement state of the third radio station based on the plurality of candidate sequences and the generation model. For example, it is possible to adjust the inter-process movement probability according to elements such as procedure design and layout of the production line and the degrees of skill of workers. Thus, it is possible to narrow down the number of combinations of candidate sequences efficiently.

Further, the path estimation system in the embodiment of the present disclosure includes a display that displays an estimation result in which the movement state of the third radio station is estimated. Thus, through the display, the user can distinguish, for example, process-in-operation information, processes conducted by a worker who holds the third radio station and is associated with the third radio station, the order of the processes conducted by the worker, and a path in which the worker has moved between the processes, and can perform determination of work efficiency improvement and/or process improvement or the like.

Further, the path estimation system in the embodiment of the present disclosure displays estimation results in which movement states of a plurality of third radio stations are estimated. For example, paths in which a plurality of workers who holds a plurality of third radio stations, respectively, and is associated with the plurality of third radio stations, respectively, has moved between processes, or the like, are displayed with different colors and/or patterns of lines so as to facilitate a distinction. Since the paths in which the workers have moved between the processes, or the like are more easily distinguished thereby, the user can perform determination of work efficiency improvement and/or process improvement or the like.

In the embodiment described above, the expressions “. . . processor”, “. . . -er”, “. . . -or”, and “. . . -ar” may be replaced with other expressions such as “. . . circuitry”, “. . . assembly”, “. . . device”, “. . . unit”, or “. . . module”.

Although the embodiment has been described above with reference to the accompanying drawings, the present disclosure is not limited to such examples. It is obvious that a person skilled in the art can arrive at various variations and modifications within the scope described in the claims. It is understood that such variations and modifications also belong to the technical scope of the present disclosure. Further, components in the embodiment described above may be arbitrarily combined without departing from the spirit of the present disclosure.

The present disclosure can be realized by software, hardware, or software in cooperation with hardware. Each functional block used in the description of the embodiment described above can be partly or entirely realized by an LSI such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

### Summary of Embodiment

A learning apparatus according to an exemplary embodiment of the present disclosure includes: collection circuitry, which, in operation, collects process-in-operation information, which indicates an operation state of each process, and reception level information, which includes a reception level of a signal received by a first radio station from a second radio station installed in each process; and learning circuitry, which, in operation, causes a generation model for estimating a movement state of a third radio station to be learned by using training data in which the process-in-operation information and the reception level information are associated for each process.

In the learning apparatus described above, the generation model is a conditional variational autoencoder including: an encoder that compresses the reception level information, which is inputted into the encoder, into a low-dimensional latent variable; and a decoder that reconstructs the reception level information by using the latent variable.

In the learning apparatus described above, the learning circuitry learns parameters of the encoder, the latent variable, and the decoder so as to minimize an error between the reconstructed reception level information and the reception level information inputted into the encoder.

A path estimation system according to an exemplary embodiment of the present disclosure includes: the learning apparatus described above; and estimation circuitry, which, in operation, estimates the movement state based on a process-in-operation information sequence, a reception level information sequence including reception levels of signals received by the third radio station from a plurality of the second radio stations, and the generation model.

In the path estimation system described above, the estimation circuitry estimates the movement state by generating a plurality of candidate sequences from the process-in-operation information sequence based on an inter-process movement probability, reconstructing a plurality of the reception level information sequences corresponding to the plurality of candidate sequences, respectively, based on the plurality of candidate sequences and the generation model, and selecting, based on similarity between the reception level information sequence and each of the plurality of the reconstructed reception level information sequences, a candidate sequence corresponding to the movement state from the plurality of candidate sequences.

The path estimation system described above further includes a monitor that displays an estimation result in which the movement state of the third radio station is estimated.

In the path estimation system described above, a plurality of the third radio stations is present and the monitor displays estimation results in which movement states of the plurality of third radio stations are estimated.

A learning method according to an exemplary embodiment of the present disclosure includes: collecting process-in-operation information, which indicates an operation state of each process, and reception level information, which includes a reception level of a signal received by a first radio station from a second radio station installed in each process; and causing a generation model for estimating a movement state of a third radio station to be learned by using training data in which the process-in-operation information and the reception level information are associated for each process.

The disclosure of Japanese Patent Application No. 2021-114136, filed on Jul. 9, 2021, including the specification, drawings and abstract, is incorporated herein by reference in its entirety.

### Industrial Applicability

An exemplary embodiment of the present disclosure is useful for a path estimation system.

### Reference Signs List

100 Path estimation system

101 Worker

102 Portable sensor

103 Process sensor

104 Parent station

105 Reception level information collector

106 Process information collector

107 Training data storage

108 Learner

109 Path estimator

110 Display

1081 Encoder

1082, 1082a Latent variable

1083, 1083a Decoder

1084, 1084a Generation model

1085 Error learner

1. A learning apparatus, comprising:
collection circuitry, which, in operation, collects process-in-operation information and reception level information, the process-in-operation information indicating an operation state of each process, the reception level information including a reception level of a signal received by a first radio station from a second radio station installed in each process; and
learning circuitry, which, in operation, causes a generation model for estimating a movement state of a third radio station to be learned by using training data in which the process-in-operation information and the reception level information are associated for each process.

2. The learning apparatus according to claim 1, wherein
the generation model is a conditional variational autoencoder including:
an encoder that compresses the reception level information into a low-dimensional latent variable, the reception level information being inputted into the encoder; and
a decoder that reconstructs the reception level information by using the latent variable.

3. The learning apparatus according to claim 2, wherein
the learning circuitry learns parameters of the encoder, the latent variable, and the decoder so as to minimize an error between the reconstructed reception level information and the reception level information inputted into the encoder.

4. A path estimation system, comprising:
the learning apparatus according to claim 1; and
estimation circuitry, which, in operation, estimates the movement state based on a process-in-operation information sequence, a reception level information sequence, and the generation model, the reception level information sequence including reception levels of signals received by the third radio station from a plurality of the second radio stations.

5. The path estimation system according to claim 4, wherein
the estimation circuitry estimates the movement state by
generating a plurality of candidate sequences from the process-in-operation information sequence based on an inter-process movement probability,
reconstructing a plurality of the reception level information sequences based on the plurality of candidate sequences and the generation model, the plurality of reception level information sequences corresponding to the plurality of candidate sequences, respectively, and
selecting, based on similarity between the reception level information sequence and each of the plurality of the reconstructed reception level information sequences, a candidate sequence corresponding to the movement state from the plurality of candidate sequences.

6. The path estimation system according to claim 4, further comprising a monitor that displays an estimation result in which the movement state of the third radio station is estimated.

7. The path estimation system according to claim 6, wherein
a plurality of the third radio stations is present and the monitor displays estimation results in which movement states of the plurality of third radio stations are estimated.

8. A learning method, comprising:
collecting process-in-operation information and reception level information, the process-in-operation information indicating an operation state of each process, the reception level information including a reception level of a signal received by a first radio station from a second radio station installed in each process; and
causing a generation model for estimating a movement state of a third radio station to be learned by using training data in which the process-in-operation information and the reception level information are associated for each process.
